(19) United States
(12) Patent Application Publication
(10) Pub. No.: US 2013/0276366 A1
(43) Pub. Date: Oct. 24, 2013

(54) DENSIFIED ORGANIC MATERIAL FOR LANDSCAPING, METHOD OF MANUFACTURE AND METHOD OF APPLICATION

(71) Applicant: Edward William DRUFFNER, Downington, PA (US)

(72) Inventor: Edward William DRUFFNER, Downington, PA (US)

(73) Assignee: U.S. Recycled Wood Products Inc., Leola, PA (US)

(21) Appl. No.: 13/454,264

(22) Filed: Apr. 24, 2012

(51) Int. Cl. A01G 1/00; A01N 25/34; B27N 5/00; C05F 11/00

(52) U.S. Cl. 47/9; 71/23; 504/116.1; 264/109

(57) ABSTRACT

A formed densified organic material for use as landscape mulch and method of manufacture and application are disclosed. The formed densified organic material is made by drying a loose mixture of mulch material and compressing the loose mixture of mulch material into a formed densified organic material. The method of apply includes: placing formed densified organic mulch on the ground at spaced locations; adding moisture to the densified organic mulch, allowing the densified organic mulch to absorb the moisture, causing the densified organic mulch to expand and reconstitute back into its original state of loose mulch; and spreading the loose mulch as required. The formed densified organic material has a moisture content of less than approximately 20 percent, a density greater than approximately 40 pounds per cubic foot, and a weigh less than approximately 5 pounds.

### FIELD OF THE INVENTION

The present invention is directed to a densified organic material for landscaping, such as densified, dried mulch material, to be reconstituted by the addition of moisture and a method of manufacture and method of application thereof.

### BACKGROUND OF THE INVENTION

Mulch, as well as other landscape materials, is available for purchase in a variety of forms. For example, mulch, sand, black dirt and stones can be purchased in bulk, in boxes and in bags. Depending on the quantity required, one packaging method may be more cost effective and/or labor effective than another. Wood mulch is produced by machines that shred wood to make piles of shredded mulch. Shredded mulch can be used for landscaping, an evaporation barrier, and water erosion prevention, among other uses. For landscaping jobs using mulch, the mulch is typically purchased in large bags or for larger jobs a large load of mulch is dumped at the worksite. Such dumps generally are done near the street where a truck can dump the mulch. The mulch is then transported to the desired area of application by wheelbarrow, bobcat, or some other type of equipment. The mulch is ultimately spread out over the region to be landscaped.

Thus, the shipment of mulch is complicated by the need for large transport beds, such as pickups or dump trucks. The placement of the mulch is further complicated by multiple trips from the dump pile to the exact deposit sites, which can destroy the landscape over which the mulch is transported. The movement of the mulch to the proper location is generally done as soon as possible because the dump site can be on a street or driveway that cannot be blocked for long periods of time.

Briquetting and densification of organic material has been pursued primarily for alternative energy purposes for prolonged burn times, cleaner more efficient burning, and maximizing transportation and logistical efforts. In addition, other biomass materials have been briquetted by U.S. Recycled Wood Products, Inc., such as switch grass, cocoa shells, peanut shells, and corn fodder, in the pursuit of alternative fuel products. In such processes, additional of chemicals may be used to add colored flames or creosote cleaning chemicals via metered crystal introduction to the biomass prior to the bricking chamber. A characteristic of densifying biomass is the moisture content has to be low to increase the net BTU content of the material. This increases the density of briquette and increases the integrity by reducing any gassing of moisture vapor at the point of compression.

There is a need in the art for improved ways to package and deliver mulch to worksites. The mulch should be package in convenient ways to facilitate transport, handling and distribution to the proper location. In particular, there is a need to provide mulch which is easy to handle and which has reduced volume and weight compared to traditional mulch, while still providing approximately the same amount of coverage as traditional mulch.

### SUMMARY OF THE INVENTION

An exemplary embodiment of the invention is directed to a cleaner, more efficient method of transporting and applying mulch. A desired amount of fertilizers, weed preventers, seeds etc. may be added.

An exemplary embodiment of the invention is directed to a briquette of mulch and a method of mulch application through a dried and densified briquette to cover a given area greater than briquette's area through the application of water. The briquette may be made from, but not limited to, organic material made of, but not restricted to, wood chips, leaves, bark, (natural, died, or composted) shells, and the like. The raw material is dried to less than 20% moisture content by weight, compressed in a briquetting operation into a defined shape such as, but not limited to rectangular, square or cylindrical with a density greater than 30 lbs/cubic ft and less than 65 lbs/cubic foot. The briquette is placed into the area of application in which water is applied, causing a hydroscopic reaction in which the moisture moves into the wood, causing the briquette to expand into a loose product providing a metered amount of material for desire area coverage depth.

An exemplary embodiment of the invention is also directed to a dried densified briquette of mulch and a method of landscape application and spreading of the mulch with or without additional additives or chemical agents such as fertilizer, seed or weed restrictant. The densified briquette of mulch can be reconstituted through the re-introduction of moisture by nature or man. Through absorption back into the cells of the organic material, the briquette expands providing the proper coverage of mulch material per given area. The expansion may also cause the even distribution of fertilizer, seed, weed restrictant or other additives or chemical agents.

An exemplary embodiment of the invention is also directed to the use of a densified briquette for distributing mulch in a landscaping application by means of a briquette weighing approximately 1 pound to approximately 3 pounds reconstituted with the addition of moisture or water for the proper applied depth of loose mulch of approximately 1 inch to approximately 4 inches of depth.

An exemplary embodiment of the invention is directed to a method of making a formed densified organic material for use in landscape mulching. The method includes: drying a loose mixture of mulch material; and compressing the loose mixture of mulch material into a formed densified organic material.

An exemplary embodiment of the invention is directed to a formed densified organic material for use as landscape mulching. The formed densified organic material having a moisture content of less than approximately 20 percent, a density greater than approximately 40 pounds per cubic foot, and a weigh less than approximately 5 pounds.

An exemplary embodiment of the invention is directed to a method of apply mulch to a landscape. The method includes: placing formed densified organic mulch on the ground at spaced locations; adding moisture to the densified organic mulch, allowing the densified organic mulch to absorb the moisture, causing the densified organic mulch to expand and reconstitute back into its original state of loose mulch; and spreading the loose mulch as required.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of an illustrative embodiment of organic material densified in the shape of a briquette.

FIG. 2 is an illustrative schematic diagram or flowchart of the method or process of manufacturing the densified organic ground cover.

FIG. 3 is an illustrative schematic diagram or flowchart of the method or process of using or distributing the densified organic ground cover.

FIG. 4 is an illustrative diagrammatic view of several representative briquettes, as shown in FIG. 1, placed on the ground.

FIG. 5 is an illustrative diagrammatic view of the representative briquettes if FIG. 4, showing water being dispersed thereon.

FIG. 6 is an illustrative diagrammatic view of the representative briquettes if FIG. 4, showing the coverage of the organic ground cover after the introduction of water and after some additional spreading.

### DETAILED DESCRIPTION OF THE INVENTION

Landscape mulch known in the industry, whether in bulk or bagged form, has a low density and high moisture content. As an example, a bag of 2 cubic ft of traditional mulch weighs more than 30 pounds. Due to the size and weight no more than 50 bags of traditional mulch are provided on a pallet with a height approximately 4 feet. A cubic yard of the traditional loose bulk or bagged mulch can contain more than 60 percent water by weight, increasing the overall weight of the mulch and reducing the amount of mulch provided on a vehicle. Known baled mulch still has considerable moisture and spread in the same manner as bagged mulch. Therefore, a large truck is necessary to move and deliver the traditional mulch material. At the jobsite, shovels, wheelbarrows, skid steers, and much labor is necessary to apply the traditional material to the intended coverage area, as moving a water heavy and bulky material is labor intensive.

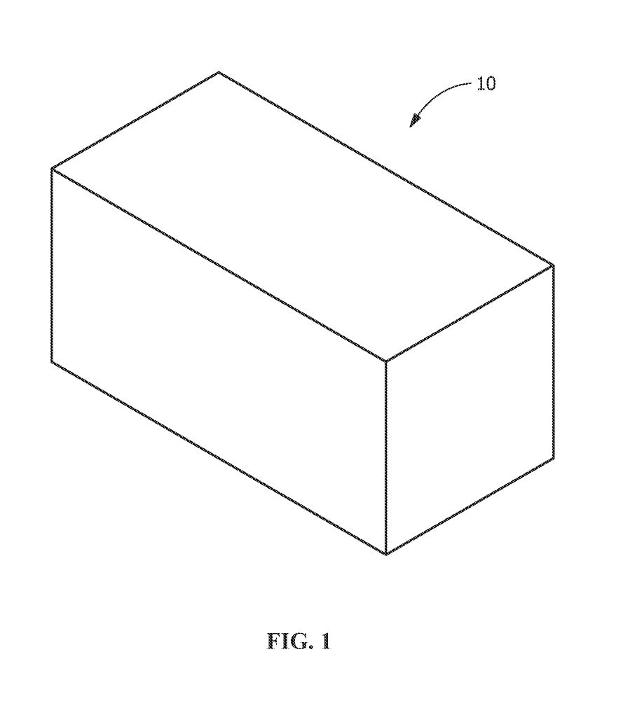

In contrast, the present invention is directed to formed densified organic material 10, such as but not limited to densified, dried briquette of mulch material, as illustrated in the exemplary embodiment shown in FIG. 1. Moisture weight is reduced to less than 20 percent by weight, and density is increased to greater than 40 pounds per cubic foot allowing more material in given space. The formed densified organic material 10, as represented by the briquettes are placed by hand, and then moisture is applied where the formed densified organic material 10 reconstitutes itself into loose mulch resulting in the ideal amount of mulch per intended coverage area. Additionally, chemical agents or additives such as but not limited to, fertilizer, seed, weed control, etc can be metered into the production of the formed densified organic material 10, thereby providing a controlled application method with the formed densified organic material 10.

As will be more fully described below, the formed densified organic material 10 of the present invention allows more material to be transported and stored in the same area as previously required for traditional mulch. The formed densified organic material 10 is dry and neatly packaged, thereby being easily applied to landscapes by simply placing formed densified organic material 10 evenly apart. As the formed densified organic material 10 absorb moisture, the formed densified organic material 10 expand and reconstitute back to loose mulch, thereby providing the ideal amount of mulch for desired depth per area.

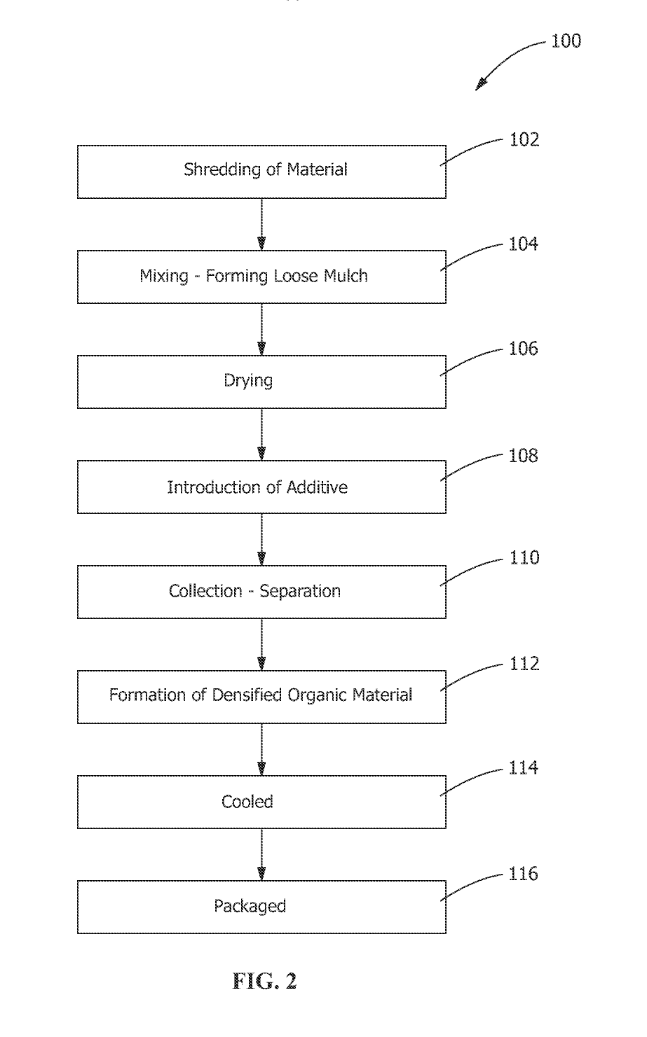

Referring to FIG. 2, a method 100 of making the formed densified organic material 10 is illustrated. As shown in box 102, biomass material is shredded into appropriate sized pieces. While sizes may vary, it is common for the pieces to be shredded to a size of 2 inches or less. Various types of wood may be shredded and used for the formed densified organic material 10. Examples include, but are not limited to Western Red Cedar, Cypress, Premium Hardwood and may include, but are not limited to colored mulches including black, brown, red, gold, natural and variations thereof.

The shredded material is then mixed or composted with other organic material, such as, but not limited to wood chips, shavings, leaves, grass clippings, landscape waste, compost, etc., as shown in 104, to form a mixture of organic material or mulch which can be used for landscaping. Additionally dye may be added for color. The steps shown in 102 and 104 are well known and are used to form traditional bulk mulch, traditional bagged mulch, traditional bailed mulch, and the formed densified organic material 10 of the present invention.

The formulated mixture is then placed on a drying belt, in a tumble dryer in a kiln, or other known drying mechanism, as represented at 106. The mixture, which may generally have a moisture content of greater than 40 percent, and likely more than 60 percent, is dried to a desired moisture content of less than 20 percent, preferably between approximately 4 percent to approximately 19 percent, and more preferably between approximately 8 percent to approximately 15 percent.

Once dried, a prescribed amount of additive, such as, but not limited to fertilizer, seed, weed control, etc, may be added as represented at 108. If added, the final formed densified organic material 10 will have the additive distributed throughout, thereby resulting in a desired application rate per area of coverage by the formed densified organic material 10. The application rate will be controlled by the amount of additive introduced during this step. The introduction of the additive is optional step and is not required if the formed densified organic material 10 is not required to fertilize, control weeds, etc.

As illustrated in box 110, material is conveyed to a collection chamber. An appropriate amount of loose material is then separated and conveyed to a hopper feeder of a briquette machine, such as that shown in U.S. Pat. No. 5,873,304, which is hereby incorporated in its entirety herein. This pre-charging of briquette machine or loading is controlled and measured. As an example if the desired mulch thickness is to be between approximately 1 inch per square foot to approximately 4 inches per square foot, the amount of mulch material loaded into the briquette machine is between approximately 1 pound to approximately 4 pounds. The appropriate amount of material loaded can vary and is dependent upon many factors, including, but not limited to, the particle size of the mulch product, the moisture of the raw materials as it related to the size of the final formed densified organic material 10, the depth of mulch desired and the coverage area desired.

The loose organic material or mulch material is feed from the hopper feeder to a hydraulic station of the briquette machine described above. The briquette machine applies pressure to the loose material, thereby compacting the loose material to form the formed densified organic material 10, as represented at 112. As an example, the compression forces generated are greater than 20,000 psi to densify loose mulch to greater than 40 pounds per cubic foot. No binder is necessary as the natural lignin in the biomass portion will provide brick cohesion. The organic material is densified to greater than approximately 40 pounds per cubic foot, preferably between approximately 45 pounds per cubic foot to approximately 65 pounds per cubic foot, and more preferably between approximately 50 pounds per cubic foot to approximately 60 pounds per cubic foot, and more preferably to approximately 55 pounds per cubic foot.

The formed densified organic material 10 is then cooled as shown at 114 and packaged as shown at 116. Any types of traditional packaging can be used, including, but not limited to, shrink wrapping, plastic bags, canvas, corrugated container, strapping with banding material for case quantities. This packaging may be done on individual formed densified organic material 10 or on groupings of formed densified organic material 10. The formed densified organic material 10, as shown at 118, is then placed on pallets for ease of transportation and storage. As an example, the formed densified organic material 10 may be positioned on pallets to provide an overall density volume of the pallet of greater than 40 lbs per cubic foot. Other size of pallets can be used to provide different density volumes.

The method described provides formed densified organic material 10, such as briquettes that, in various embodiments, can be hand loaded and carried to a workplace destination. The formed densified organic material 10 provides a more efficient, hand portable, packaging than traditional wood mulch packaging. The formed densified organic material 10 allows for efficient transportation since they are a dense package of the wood mulch. They can be hand carried to a desired destination, thereby avoiding the need to have machinery cross a current landscape. The formed densified organic material 10 also allows for relatively inexpensive and/or ecological packaging of wood mulch.

The formed densified organic material 10 formed from the process can have a variety of shapes, weights and densities depending on the parameters described above. In the exemplary embodiment shown in FIG. 1, the formed densified organic material 10 is formed into a briquette with dimensions of approximately 2.5 inches by approximately 6 inches by approximately 3 inches. Alternatively, the formed densified organic material 10 may have different dimensions or different shapes, including, but not limited to cube, log or cylindrical.

As previously described, the density of the formed densified organic material 10 may vary. However, the formed densified organic material 10 generally has a density greater than approximately 40 pounds per cubic foot, preferably between approximately 45 pounds per cubic foot to approximately 65 pounds per cubic foot, and more preferably between approximately 50 pounds per cubic foot to approximately 60 pounds per cubic foot, and more preferably to approximately 55 pounds per cubic foot.

The moisture content of the formed densified organic material 10 is generally less than 20 percent, preferably between approximately 4 percent to approximately 19 percent, and more preferably between approximately 8 percent to approximately 15 percent.

Depending upon the other variables described and the amount of coverage desired, the weight of the formed densified organic material 10 may also vary. Generally, the formed densified organic material 10 will weigh less than approximately 5 pounds, preferably between approximately 1 pound to approximately 3 pounds, and more preferably between approximately 1.25 pounds to approximately 2.5 pounds. As an example, a formed densified organic material 10 weighing approximately 1.25 pounds to approximately 2.5 pounds will provide coverage of approximately 1.5 inches to approximately 3.5 inches of mulch per square foot of landscaped area when moisture is added to the formed densified organic material 10, as will be more fully described.

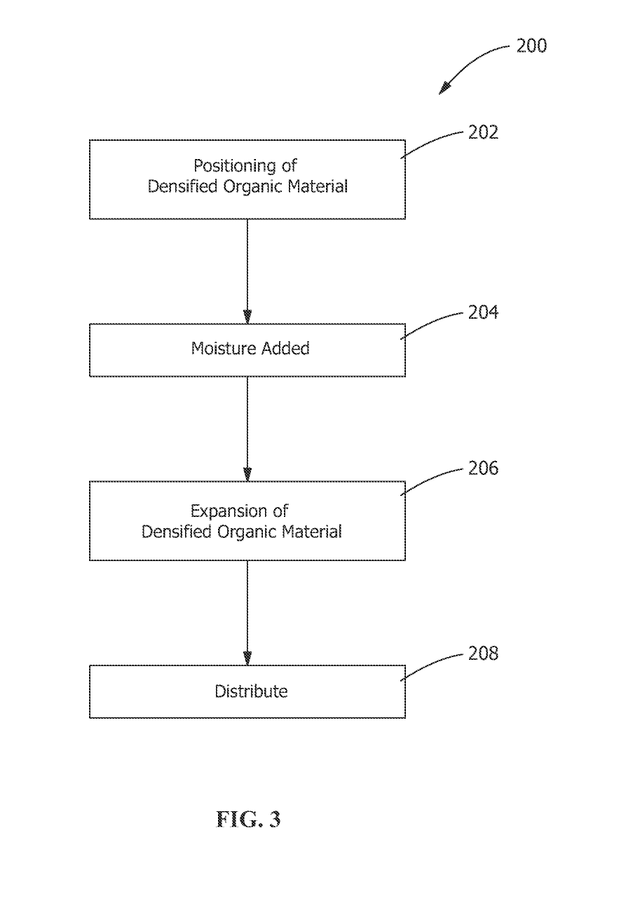

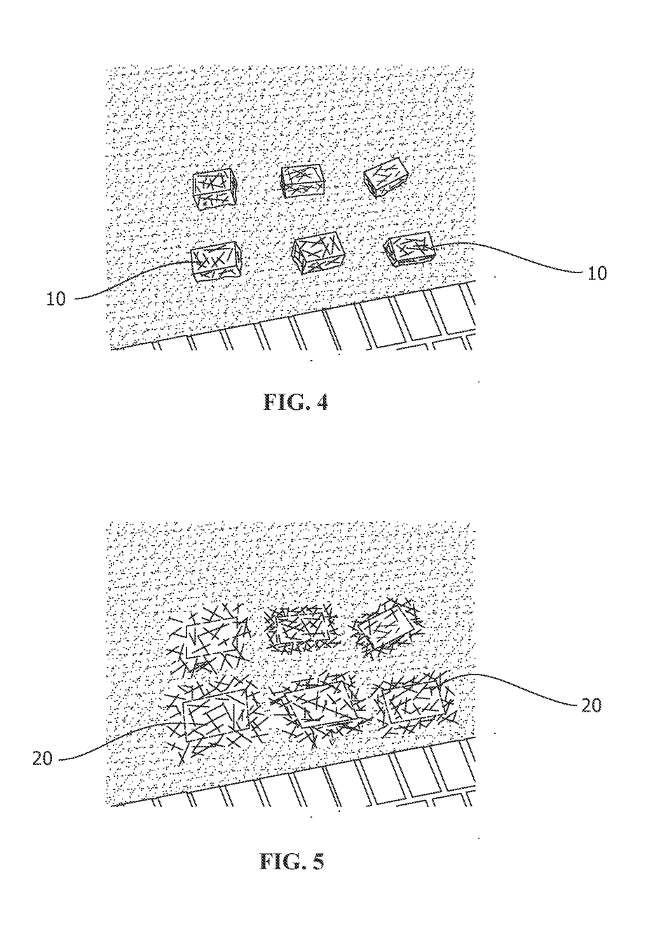

The method 200 of applying the formed densified organic material 10 to the landscape will now be described with reference to FIGS. 3 through 6. As shown at 202, the formed densified organic material 10 are carried to the appropriate site and placed on the ground. While tools can be used to carry and/or apply the densified organic material 10, due to the small size and weight of the formed densified organic material 10, the formed densified organic material 10 does not require the use of tools to carry and/or apply the densified organic material 10. As shown in FIG. 4, the formed densified organic material 10 is placed on the ground at the recommended distance apart to provide desired depth of finished loose mulch material per square foot. For example, the formed densified organic material 10 may be placed at intervals of 1 brick per square foot. The recommended spacing can vary and is dependent upon many factors, including, but not limited to, the size of the final formed densified organic material 10, the depth of mulch desired and the coverage area desired.

Once positioned, moisture is added to the placed formed densified organic material 10, as shown at 204 in FIG. 3 and in FIG. 5, by means of but not limited to by rain, garden hose, sprinkler, watering can, or the like. In addition to or instead of the above, the formed densified organic material 10 may absorb moisture from the ground, particularly if the ground is moist.

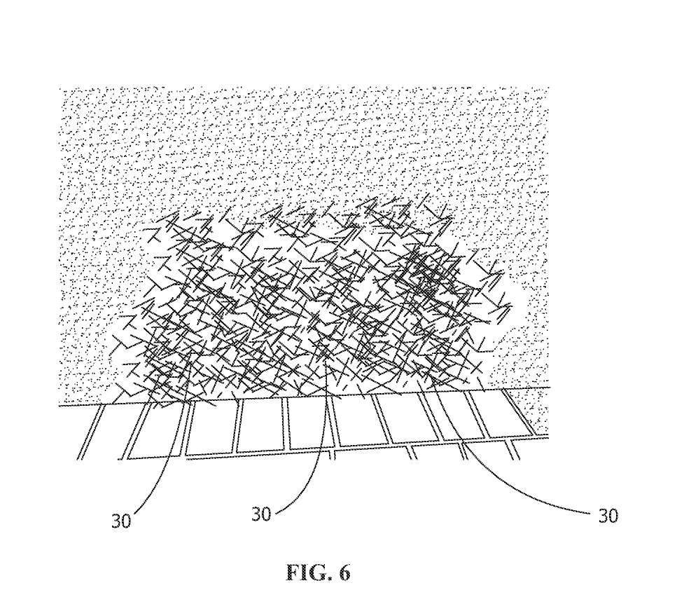

As represented at 206, once moisture is introduced to the formed densified organic material 10, the formed densified organic material 10 will absorb the moisture, expand rapidly, and reconstitute back into its original state of loose mulch, as represented at 20 in FIG. 5, thereby substantially increasing their extent of ground cover and providing the desired depth of material per square foot. The loose mulch material is then raked, spread or broadcast as necessary to even out coverage and appearance of mulched landscape, as represented at 208 and as shown at 30 in FIG. 6.

The formed densified organic material described herein, as compared to known bagged and bulk mulch, have the advantage of allowing more mulch to be delivered per truckload. In one example, approximately 13 cubic yards of mulch may be delivered in 1000 briquettes weighing 2000 pounds housed in a pallet measuring 42 inches by 48 inches by 36 inches. Therefore, in a typical delivery truck, the amount of bulk mulch which could be delivered would be approximately 65 to 80 yards, the amount of bagged much would be approximately 90 to 100 yards and the amount of briquettes would be approximately 280 to 320 yards. The use of the formed densified organic material allows for approximately 3 to 4 more mulch to be delivered per truckload.

Other advantages include: less CO2 emissions from truck traffic for delivery both on the wholesale and retail level; less plastic packaging per quantity of mulch compared to bagged; at least 3 times more mulch material per pallet foot print; and the pallets are solid and stackable to at least 4 high adding 12 times more mulch compared to unstackable bagged mulch.

The formed densified organic material can also have additional additives, such as, but not limited to, fertilizer, seed or weed preventer added. This provides each formed densified organic material with metered coverage and prevents over application. The introduction of seed also provides and erosion control element.

The formed densified organic material can be placed by hand. As an example, 10 yards of mulch contained in 1000 formed densified organic material can be placed by hand, one formed densified organic material per foot, by 2 men in less than 2 hours, thereby mulching 1000 sq ft. This provides an even coverage per square foot. This amount of material can be delivered in the back of a pickup truck. There are no dump loads, less weight, no shoveling, less labor, and cleaner delivery.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of making a formed densified landscape mulch, the method comprising:
mixing shredded wood with other organic material to form a formulated mixture;
drying the formulated mixture;
compressing the formulated mixture into the formed densified landscape mulch;
wherein for every one inch per square foot of mulch thickness desired when the formed densified landscape mulch is applied, approximately one pound of formulated mixture is dried and compressed.

2. The method as recited in claim 1 wherein the formulated mixture is dried such that the formed densified landscape mulch has a moisture content of less than 20 percent and the formed densified landscape mulch is compressed to greater than approximately 40 pounds per cubic foot.

3. The method as recited in claim 2 wherein the formulated mixture is dried such that the formed densified landscape mulch has moisture content of between approximately 4 percent to approximately 19 percent and the formed densified landscape mulch is compressed to between approximately 45 pounds per cubic foot to approximately 65 pounds per cubic foot.

4. The method as recited in claim 3 wherein the formulated mixture is dried such that the formed densified landscape mulch has moisture content of between approximately 8 percent to approximately 15 percent and the formed densified landscape mulch is compressed to between approximately 50 pounds per cubic foot to approximately 60 pounds per cubic foot.

5. The method as recited in claim 1 wherein lignin provided in the mulch material will provide cohesion when the formulated mixture is compressed into the formed densified landscape mulch.

6. The method as recited in claim 1 wherein the formed densified landscape mulch is formed into a briquette, square or cylinder.

7. The method as recited in claim 1 wherein additives containing fertilizer, seed or weed control are added to the formulated mixture prior to compressing the formulated mixture of mulch material into the formed densified landscape mulch.

8. A formed densified landscape mulch comprising a moisture content of less than approximately 20 percent, a density greater than approximately 40 pounds per cubic foot, a weigh less than approximately 5 pounds, and approximately one pound of a dried and compressed formulated mixture for every one inch of mulch thickness desired when the formed densified landscape mulch is applied and moistened.

9. The formed densified landscape mulch as recited in claim 8 wherein the moisture content is between approximately 4 percent to approximately 19 percent.

10. The formed densified landscape mulch as recited in claim 9 wherein the moisture content is between approximately 8 percent to approximately 15 percent.

11. The formed densified landscape mulch as recited in claim 8 wherein the density is between approximately 45 pounds per cubic foot to approximately 65 pounds per cubic foot.

12. The formed densified landscape mulch as recited in claim 11 wherein the density is between approximately 50 pounds per cubic foot to approximately 60 pounds per cubic foot.

13. The formed densified landscape mulch as recited in claim 8 wherein the weight is between approximately 1 pound to approximately 3 pounds.

14. The formed densified landscape mulch as recited in claim 13 wherein the weight is between approximately 1.25 pounds to approximately 2.5 pounds.

15. The formed densified landscape mulch as recited in claim 8 wherein the formed densified landscape mulch is a briquette, square or cylinder.

16. The formed densified landscape mulch as recited in claim 8 wherein additives containing fertilizer, seed or weed control are distributed through the formed densified landscape mulch.

17. A method of apply mulch to a landscape, the method comprising:
placing formed densified organic mulch on the ground at spaced locations;
adding moisture to the densified organic mulch, allowing the densified organic mulch to absorb the moisture, causing the densified organic mulch to expand and reconstitute back into its original state of loose mulch; and
spreading the loose mulch as required.

18. The method as recited in claim 17 wherein additives such as fertilizer, seed or weed control are distributed through the densified organic mulch, the additives being spread when the loose mulch.

19. The method as recited in claim 17 wherein the densified organic mulch has a moisture content of less than 20 percent.

20. The method as recited in claim 17 wherein the densified organic mulch has a density greater than approximately 40 pounds per cubic foot.

21. The method as recited in claim 17 wherein the densified organic mulch has a weigh less than approximately 5 pounds.
